(19) United States
(12) Patent Application Publication
(10) Pub. No.: US 2024/0222652 A1
(43) Pub. Date: Jul. 4, 2024

(54) ULTRA-LOW PLATINUM GROUP METAL CONTAINING ANODE ELECTROCATALYSTS FOR ACID MEDIATED PROTON EXCHANGE MEMBRANE FUEL CELLS

(71) Applicant: UNIVERSITY OF PITTSBURGH - OF THE COMMONWEALTH SYSTEM OF HIGHER EDUCATION, Pittsburgh, PA (US)

(72) Inventors: Prashant N. Kumta, Pittsburgh, PA (US); Shrinath Dattatray Ghadge, Pittsburgh, PA (US); Oleg Velikokhatnyi, Pittsburgh, PA (US); Moni Kanchan Datta, Pittsburgh, PA (US)

(21) Appl. No.: 18/550,084

(22) PCT Filed: Mar. 4, 2022
(86) PCT No.: PCT/US2022/018872

§ 371 Date: Sep. 11, 2023

Related U.S. Application Data
(60) Provisional application No. 63/158,939, filed on Mar. 10, 2021.

(51) Int. Cl. H01M 4/92; C01B 33/06

(52) U.S. Cl. CPC H01M 4/921; C01B 33/06; H01M 4/923; C01P 2002/50; C01P 2002/72; C01P 2002/85; C01P 2004/03; C01P 2006/40

(57) ABSTRACT

The invention relates to systems and methods for successful operation of acid mediated proton exchange membrane fuel cell (PEMFC), and highly efficient, earth-abundant, and ultra-low noble metal-containing, e.g., platinum group metal (PGM)-containing, electrocatalyst materials for anodic hydrogen oxidation reaction (HOR). The electrocatalyst materials include metal silicide alloy-based solid solutions of the general formula: (A₍ₙ₋ₓ₎Bₓ)Si_{y}, wherein A is a transition metal element or mixture or alloy thereof, B is a noble metal element or mixture or alloy thereof, and each of n and x, is a positive integer or a positive fractional number, and y is a positive integer.

### CROSS-REFERENCE TO RELATED APPLICATION

This application claims priority under 35 U.S.C. 119(e) to U.S. Provisional Patent Application Ser. No. 63/158,939, filed on Mar. 10, 2021, entitled, “ENGINEERING HIGH PERFORMANCE EARTH ABUNDANT AND ULTRA-LOW PLATINUM GROUP METAL CONTAINING ANODE ELECTROCATALYSTS FOR ACID MEDIATED PROTON EXCHANGE MEMBRANE FUEL CELLS,” which is herein incorporated by reference.

### GOVERNMENT SUPPORT

This invention was made with government support under grants 1511390 and 0933141 awarded by the National Science Foundation (NSF). The government has certain rights in the invention.

### FIELD OF THE INVENTION

The invention relates to systems and methods for successful operation of an acid mediated proton exchange membrane fuel cell (PEMFC), and highly efficient, earth-abundant, and ultra-low noble metal-containing, e.g., ultra-low platinum group metal (PGM)-containing, electrocatalyst materials for anodic hydrogen oxidation reaction (HOR).

### BACKGROUND

The proton exchange membrane fuel cell (PEMFC) has received significant attention over the years for offering a promising and sustainable approach for power production with reduced greenhouse gas emissions, and higher efficiency in comparison to conventional combustion-based technologies. There has been significant research over the years directed towards the development of efficient and robust HOR electrocatalysts for generation of clean hydrogen for energy production. These PEMFC-based technologies can potentially exhibit higher efficiency in comparison to the current combustion-based technologies.

However, in spite of the promising attributes of PEMFCs, in order to fulfill the optimistic potential of PEMFCs and consequently their large scale commercialization, there is a critical need to identify earth abundant and inexpensive electrocatalyst systems which can unveil high electrocatalytic performance for oxygen reduction reactions (ORR) and hydrogen oxidation reactions (HOR), in comparison to the state-of-the-art and expensive noble metal, e.g., platinum group metal (PGM), based electrocatalysts. Although significant advancements have been attained regarding identification and development of ultra-low noble metal-containing as well as noble metal-free, e.g., PGM-containing as well as PGM-free, ORR electrocatalysts for PEMFC, less attention has been paid to generating reduced noble metal-based, e.g., PGM-based, HOR electrocatalysis. In the pursuit of lowering the cost of noble metal-based, e.g., PGM-based, electrocatalysts, one of the widely employed practical approaches is alloying or incorporation of a lower amount of noble metal (e.g. Pt, Ir, Ru) by reacting with the earth abundant and inexpensive transition metals such as Sn, Ni, Mo, Fe, Ti and the like, resulting in improved electronic structure and therefore, offering electrochemical performance comparable or superior to the noble and precious group metal-based electrocatalyst.

It has been demonstrated that the high performance of Pt-supported or reduced Pt-containing electrocatalysts is ascribed to the reduction in the Pt—Pt interatomic distance, uniform dispersion of Pt over the support material, and beneficial modification in the electronic structure of the solid solution-based Pt-containing electrocatalysts, offering high electrocatalytic activity owing to the optimal adsorption/dissociation energies for hydrogen. Accordingly, in the recent years, various Pt-containing electrocatalyst systems such as Pt—Sn/C, Pt—Sn—Ir/C, Pt—Ru, Pt—Ru—Os—Ir, Pt—Co, Pt—Ti/C, Pt—Ni—Cr/C, Pt—CuO/C, Pt—Ni/C, Pt—WC, Pt—WO₃—TiO₂/C, and the like, have been investigated for the various reactions such as ethanol oxidation, ORR, and HOR, demonstrating the promise of alloying or the solid solution approach to offer reduced noble metal loading without compromising the electrochemical performance.

There is a need and desire in the art to develop new highly efficient, earth-abundant, and ultra-low platinum group metal (PGM) containing electrocatalyst materials for anodic hydrogen oxidation reaction (HOR), for successful operation of acid mediated proton exchange membrane fuel cell (PEMFC).

### SUMMARY OF THE INVENTION

In one aspect, the invention provides an anode electrocatalyst composition that includes a metal silicide alloy-based solid solution of a general formula:

$$( {A}_{( n - x )} {B}_{x} ) {Si}_{y}$$

wherein A is a transition metal element or mixture or alloy thereof, B is a noble metal element or mixture or alloy thereof, each of n and x is a positive integer or a positive fractional number, and y is a positive integer, wherein the anode electrocatalyst composition is used in an acid mediated proton exchange membrane-based hydrogen oxidation reaction.

In certain embodiments, A is selected from the group consisting of Ti, Ta, Nb, V, W, Sr, Pb, Sb, Cr, Co, Sn, Fe, Mn, Mo, Ni, and mixtures and alloys thereof.

In certain embodiments, B is selected from the group consisting of Pt, Ir, Ru, Rh, Os, Pd, and mixtures and alloys thereof.

In certain embodiments, the metal silicide alloy-based solid solution has the general formula: (Ti₍₅₋ₓ₎Ptₓ)Si₃; 0<x<5. In an exemplary embodiment, x is a positive number preferably varying from 0.2 to 0.5.

In certain embodiments, A, B and Si are in a dry form. In exemplary embodiments, the dry form is selected from the group consisting of powder, particles, flakes, rods, tubes, granules, films, and mixtures and combinations thereof. In other exemplary embodiments, the dry form comprises one or more high specific surface area nanostructured forms.

In certain embodiments, the general formula (A₍ₙ₋ₓ₎Bₓ)Si_{y} corresponds to the elemental stoichiometry of A, B and Si.

In another aspect, the invention provides a method of preparing an anode electrocatalyst composition. The method includes preparing a metal silicide alloy-based solid solution of the general formula:

$$( {A}_{( n - x )} {B}_{x} ) {Si}_{y}$$

wherein A is a transition metal element or mixture or alloy thereof, B is a noble metal element or mixture or alloy thereof, each of n and x is a positive integer or a positive fractional number, and y is a positive integer; obtaining A, B and Si in dry form; combining the A, B and Si to form a dry mixture; and high energy mechanical milling of the dry mixture to form an alloy composition.

In certain embodiments, the high energy mechanical milling process includes loading the dry mixture into a vial containing stainless-steel balls. In exemplary embodiments, the weight ratio of stainless-steel balls to powder is 5:1.

In certain embodiments, the dry form is selected from the group consisting of powder, particles, flakes, rods, tubes, granules, and mixtures and combinations thereof. In other exemplary embodiments, the dry form comprises one or more high specific surface area nanostructured forms.

In certain embodiments, the dry mixture is formed according to the elemental stoichiometry of A, B and Si.

In certain embodiments, A is selected from the group consisting of Ti, Ta, Nb, V, W, Sr, Pb, Sb, Cr, Co, Sn, Fe, Mn, Mo, Ni, and mixtures and alloys thereof.

In certain embodiments, B is selected from the group consisting of Pt, Ir, Ru, Rh, Os, Pd, and mixtures and alloys thereof.

In certain embodiments, the metal silicide alloy-based solid solution has the general formula: (Ti₍₅₋ₓ₎Ptₓ)Si₃; 0<x<5. In exemplary embodiments, x is a positive number ranging from 0.2 to 0.5.

In still another aspect, the invention provides a proton exchange membrane fuel cell that includes an anode electrocatalyst composition, which includes a metal silicide alloy-based solid solution of the general formula:

$$( {A}_{( n - x )} {B}_{x} ) {Si}_{y}$$

wherein A is a transition metal element or mixture or alloy thereof, B is a noble metal element or mixture or alloy thereof, each of n and x is a positive integer or a positive fractional number, and y is a positive integer.

In certain embodiments, A is selected from the group consisting of Ti, Ta, Nb, V, W, Sr, Pb, Sb, Cr, Co, Sn, Fe, Mn, Mo, Ni, and mixtures and alloys thereof.

In certain embodiments, B is selected from the group consisting of Pt, Ir, Ru, Rh, Os, Pd, and mixtures and alloys thereof.

In certain embodiments, the metal silicide alloy-based solid solution has the general formula: (Ti₍₅₋ₓ₎Ptₓ)Si₃; 0<x<5. In exemplary embodiments, x is a positive number ranging from 0.2 to 0.5.

In certain embodiments, A, B and Si are in a dry form. In exemplary embodiments, the dry form is selected from the group consisting of powder, particles, flakes, rods, tubes, granules, films, and mixtures and combinations thereof. In other exemplary embodiments, the dry form comprises one or more high specific surface area nanostructured forms.

In certain embodiments, the general formula (A₍ₙ₋ₓ₎Bₓ)Si_{y} corresponds to the elemental stoichiometry of A, B and Si.

### BRIEF DESCRIPTION OF THE DRAWINGS

A full understanding of the disclosed concept can be gained from the following description of the preferred embodiments when read in conjunction with the accompanying drawings, as follows:

FIG. 1 is a schematic that illustrates the synthesis process for generating the Pt-doped or Pt-alloyed Ti₅Si₃ (i.e., Ti₍₅₋ₓ₎PtₓSi₃), in accordance with certain embodiments of the invention;

FIG. 2 is a schematic that illustrates the crystal structure of Ti₅Si₃ with a Pt atom located above a triple-Ti active site at the crystallographic surface, wherein the multiple larger spheres represent Ti atoms, the multiple smaller spheres represent the Si atoms, and the triple-Ti active site is identified underlying the Pt atom, in accordance with certain embodiments of the invention;

FIG. 3 is an image of powder XRD patterns of the as synthesized electrocatalysts, in accordance with certain embodiments of the invention;

FIGS. 4a and 4b are SEM micrographs wherein FIG. 4a represents pure non-Pt alloyed Ti₅Si₃ and FIG. 4b represents, Pt incorporated or alloyed Ti_{4.7}Pt_{0.3}Si₃; FIGS. 4c-4e are elemental x-ray mapping images wherein FIGS. 4c, 4d and 4e represent Ti, Si, and Pt, respectively, and FIG. 4f is an EDX spectrum image for Ti_{4.7}Pt_{0.3}Si₃, in accordance with certain embodiments of the invention;

FIGS. 5a-5c are images of XPS spectra wherein FIG. 5a represents the spectra for Ti 2p, FIG. 5b represents the spectra for Si 2p, and FIG. 5c represents the spectra for Pt 4f, of Ti₅Si₃ and Ti_{4.7}Pt_{0.3}Si₃ electrocatalysts, in accordance with certain embodiments of the invention;

FIGS. 6a-6d are images that compare the electrochemical performances of the as-synthesized electrocatalysts measured in a H₂ saturated 1 N H₂SO₄ electrolyte at 40° C., wherein FIG. 6a shows EIS plots performed at 0.05 V (vs. RHE) in the frequency range of 100 mHz to 100 kHz, FIG. 6b shows the cyclic voltammetry (CV) curves for HOR, FIG. 6c shows the linear scan voltammogram (LSV) curves for HOR, and FIG. 6d shows the Tafel slope values, in accordance with certain embodiments of the invention;

FIGS. 7a and 7b are images wherein FIG. 7a shows a chronoamperometric response of the as-prepared Pt/C and Ti_{4.7}Pt_{0.3}Si₃ electrodes measured at 0.05 V (vs RHE), and FIG. 7b shows the polarization curves for the HOR of Ti_{4.7}Pt_{0.3}Si₃ obtained on a rotating disk electrode (RDE), measured in H₂ saturated 1N H₂SO₄ solution at 40° C. with a scan rate of 10 mV s⁻¹, wherein the inset shows a Koutechy-Levich plot of Ti_{4.7}Pt_{0.3}Si₃, in accordance with certain embodiments of the invention;

FIGS. 8a and 8b are images that illustrate the performance of a single PEMFC (initial and after 24 h of operation) wherein FIG. 8a shows the results obtained for the single PEMFC with Pt/C as the anode and the cathode electrocatalysts, and FIG. 8b shows the results obtained for the single PEMFC with Ti_{4.7}Pt_{0.3}Si₃ anode and Pt/C cathode electrocatalysts at 80° C. and 0.1 MPa with UHP-H₂ (200 ml min⁻¹) and UHP-O₂ (300 ml min⁻¹) as the reactant gases, in accordance with certain embodiments of the invention; and

FIG. 9 is an image that shows a plot of hydrogen adsorption free energy (ΔGH*) calculated for pure and Pt-doped Ti₅Si₃ at (0001) crystallographic plane, wherein the reaction coordinate axis denotes the hydrogen oxidation reaction process, in accordance with certain embodiments of the invention.

### DETAILED DESCRIPTION OF THE PREFERRED EMBODIMENTS

The invention relates to systems and methods for operation of acid mediated proton exchange membrane fuel cells (PEMFCs), and highly efficient, earth-abundant, and ultra-low noble metal-containing, e.g., ultra-low platinum group metal (PGM)-containing, electrocatalyst materials for anodic hydrogen oxidation reaction (HOR), synthesized via a simple, scalable, and economical mechanical milling process.

The invention includes the development of ultra-low noble metal-containing, e.g., Pt-containing, transition metal silicide (e.g., titanium silicide, Ti₅Si₃)-based electrocatalysts for acid mediated proton exchange membrane-based HOR. Owing to their advantageous characteristics such as high electrical and thermal conductivity, high oxidation resistance, temperature strength and creep resistance, as well as earth abundance, transition metal (e.g., Ti, Ta, Mo, W, Cr, Nb, and the like) silicides are useful for various applications in PEM-based water electrolyzers and fuel cells, such as the hydrogen/oxygen evolution reaction (HER/OER), ORR, in microelectronics and nano-electronic industries such as interconnects, ohmic contacts and gate materials of microelectronic transistors, and the like.

The highly efficient, earth-abundant, and ultra-low noble metal-containing, e.g., platinum group metal (PGM)-containing, electrocatalyst materials, according to the invention, include novel metal silicide alloy-based anode electrocatalyst compositions for HOR denoted as follows:

$$( {A}_{( n - x )} {B}_{x} ) {Si}_{y}$$

wherein A is a transition metal element, or mixtures or alloys thereof; B is a noble metal, e.g., PGM, element, or mixtures or alloys thereof; each of ‘n’ and ‘x’ is a positive integer or positive fractional number, and ‘y’ is a positive integer. The formula corresponds to the elemental stoichiometry of A, B and Si. In exemplary embodiments, the ultra-low noble metal-containing, e.g., PGM-containing, metal silicide-based compositions form solid solution electrocatalysts, e.g., single-phase solid solution electrocatalysts. In certain embodiments, A is selected from titanium (Ti), tantalum (Ta), niobium (Nb), tungsten (W), vanadium (V), strontium (Sr), lead (Pb), antimony (Sb), chromium (Cr), cobalt (Co), tin (Sn), iron (Fe), manganese (Mn), molybdenum (Mo), nickel (Ni), and mixtures and alloys thereof. In certain embodiments, B is selected from platinum (Pt), iridium (Ir), ruthenium (Ru), rhodium (Rh), palladium (Pd), osmium (Os), and the like, and mixtures and alloys thereof. In an exemplary embodiment, the PGM alloyed transition metal silicide is platinum alloyed titanium silicide (Ti₅Si₃), wherein A is Ti, B is Pt, n is 5, x varies based on the amount of Pt, and y is 3. In certain embodiments, x is within the range from greater than 0 to less than 5 (0<x<5). In certain other embodiments, x is within the range from greater than or equal to 0.2 to less than or equal to 0.5 (0.2≤x≤0.5). In other exemplary embodiments, the PGM alloyed transition metal silicide includes a transition metal silicide selected from tantalum silicide, molybdenum silicide, tungsten silicide, chromium silicide, niobium silicide, and mixtures and alloys thereof.

For ease of description, certain embodiments of platinum-doped or platinum alloyed titanium silicide-based electrocatalysts are disclosed in detail herein. However, the invention is not limited to only these particular embodiments. The invention contemplates and encompasses additional embodiments of electrocatalysts that include other transition metals and alloys thereof selected from those disclosed herein and/or known in the art, as well as various noble metals, e.g., platinum group metals (PGMs), disclosed herein and/or known in the art.

In certain embodiments, Pt-doped or alloyed titanium silicide [(Ti₍₁₋ₓ₎Ptₓ)₅Si₃]-based solid solution electrocatalysts are identified and engineered for HOR, which demonstrate high electrocatalytic activity as well as desired electrochemical and structural stability of (Ti₍₁₋ₓ₎Ptₓ)₅Si₃ electrocatalysts, wherein x is within the range from greater than 0 to less than 1 (0<x<1).

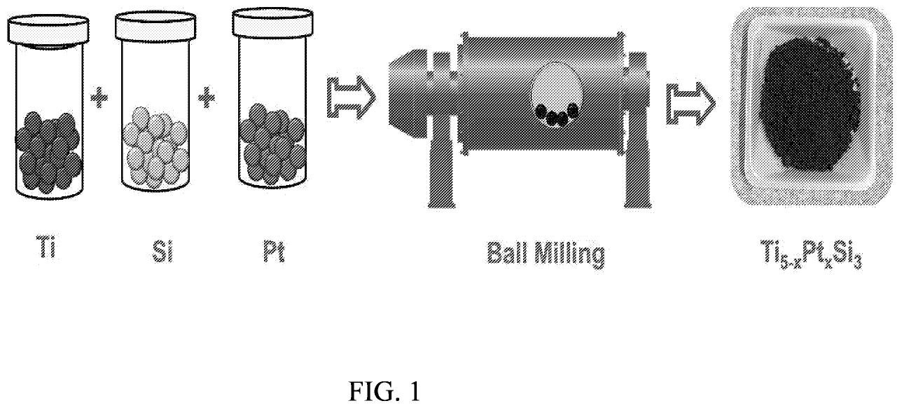

Methods of preparing the novel Pt-containing (e.g., noble metal-containing) transition metal silicide-based electrocatalysts include obtaining the precursor materials comprising the elemental transition metal, e.g., titanium, elemental silicon, and elemental Pt (e.g., 40% Pt/C) in a dry form. In certain embodiments, the dry form (of “A”, “B” and Si) includes a powder, particles, flakes, rods, tubes, granules, films, or mixtures or combinations thereof. In certain other embodiments, the dry form includes one or more high specific surface area nanostructured forms; e.g., nano-powder, nano-particles, nano-flakes, nano-rods, nano-tubes, nano-granules, or mixtures or combinations thereof. The illustration of the synthesis process, in accordance with certain embodiments of the invention, is depicted in FIG. 1. The elemental powder mixtures are prepared according to the elemental stoichiometry. Each of the Ti, Si and Pt powders (shown on the left side of FIG. 1) are mixed together in a high energy mechanical milling (HEMM) apparatus. The powders are loaded into a stainless-steel (SS) vial containing SS balls as the milling media, within the HEMM apparatus (shown as “Ball Milling” in FIG. 1). Suitable SS balls for use have a diameter of 2 mm, and a suitable ball to powder weight ratio (BPR) is 5:1. Following HEMM, the mixture, e.g., alloy composition, of Ti₍₅₋ₓ₎PtₓSi₃ (0<x<5) is produced (as shown on the right side in FIG. 1).

According to the invention, Pt-alloyed titanium silicide (Ti₅Si₃)-based novel electrocatalyst systems are identified and engineered for HOR, supplemented by density functional theory (DFT) calculations; validated by experimental findings of high electrocatalytic activity, as well as chemical and structural stability of the named silicide electrocatalysts. Following the DFT investigations, in order to enhance the surface electronic structure, electronic conductivity, and electrochemical performance of the desired electrocatalyst compositions, an ultra-low quantity of PGM (Pt) element (e.g., noble metal element) is utilized for alloying with the parent electrocatalyst system (i.e. Ti₅Si₃). The invention embodies a simple, economical, and scalable high-energy mechanical milling (HEMM) approach to generate solid solution electrocatalyst powder compositions of Ti₍₅₋ₓ₎PtₓSi₃ (0<x<5) for HOR applications in PEMFC.

The incorporation of a reduced amount of noble metal, e.g., Pt, into Ti₅Si₃, e.g., (Ti₍₅₋ₓ₎Ptₓ)Si₃, is sufficient to modify the electronic structure of the Pt-containing Ti₅Si₃. The as-synthesized alloyed solid solution electrocatalysts consequently, corresponding to the (Ti₍₅₋ₓ₎Ptₓ)Si₃ system, demonstrate significantly improved electrochemical charge transfer kinetics and electrochemical activity towards HOR in comparison to pristine (pure) Ti₅Si₃. Thus, it is concluded that the (Ti₍₅₋ₓ₎Ptₓ)Si₃ alloy system is a favorable HOR electrocatalyst for acid mediated PEMFC.

The HOR electrocatalytic activity for novel Pt-alloyed Ti₅Si₃ is significantly improved as compared to the electrocatalytic activity and kinetics for the HOR of pure unalloyed non-PGM-containing Ti₅Si₃. Similarly, Ti₅Si₃ exhibits a charge transfer resistance (Rct) of ˜43 Ω cm², while the introduction of only ˜3.75 at. % Pt to alloy with Ti₅Si₃ to form Ti_{4.7}Pt_{0.3}Si₃ alloy reveals a Rct of ˜16 Ω cm², that is substantially lower than pure Ti₅Si₃ and comparable to commercial and state-of-the art Pt/C (˜14 Ω cm²), demonstrating a beneficial improvement in electronic conductivity and reaction kinetics of the ultra-low Pt-containing Ti₅Si₃. In addition, the HOR peak current density (at ˜0.05 V vs. RHE) for Pt/C, and 2.5 and 3.75 at. % Pt alloyed Ti₅Si₃ to form Ti_{4.8}Pt_{0.2}Si₃ and Ti_{4.7}Pt_{0.3}Si₃ is ˜0.9, 0.54 and 0.75 mA cm⁻², respectively, which are significantly higher than Ti₅Si₃ (˜0.22 mA cm⁻²), while not much lower than Pt/C. This remarkable improvement in peak current density performance is attributed to an improvement in the charge transfer kinetics and HOR performance, which are in agreement and successfully validated by the DFT calculations, showing the optimal hydrogen adsorption free energies (ΔGH*) and cohesive energy (−E_{coh}) for the Pt alloyed Ti₅Si₃.

In accordance with the invention, durability tests for Ti_{4.7}Pt_{0.3}Si₃ in H₂ saturated 1N H₂SO₄ display minimal current density loss, indicating good electrochemical stability towards HOR. The electrochemical results are also competently validated by the theoretical first principles studies demonstrating the efficacy of the ultra-low PGM-containing Ti_{4.7}Pt_{0.3}Si₃ electrocatalyst composition for HOR, which is critical for the development of earth abundant and reduced PGM-containing electrocatalysts for PEMFCs.

The novel ultra-low Pt-containing solid solution alloy of Ti_{4.7}Pt_{0.3}Si₃ correlates a structural modification of the electrocatalyst with alloying of reduced PGM content to achieve improved electronic, charge transfer, and electrochemical properties of the alloyed solid solution architectures. The structural modification brought about by alloying, in turn, results in high electrocatalytic activity (current density), excellent electronic conductivity, and durability; comparable to the state-of-the art expensive and precious noble metal-based Pt/C electrocatalysts for HOR in PEMFC systems.

The invention includes one or more of the following features and benefits:
(i) Excellent electrochemical activity, lower polarization, reduced overpotential (i.e., reduced operating electricity cost), low charge transfer resistance (Rct), and excellent HOR kinetics, comparable to the PGM-based electrocatalysts such as Pt/C, IrO₂.
(ii) Excellent long-term electrochemical stability, demonstrating the mechanical integrity and structural robustness of the solid solution electrocatalyst compositions under harsh operating conditions of HOR, comparable to that of state-of-the-art noble metal electrocatalysts (Pt, IrO₂).
(iii) Rotating disk electrode (RDE) studies reveal that the number of electrons produced in the reaction (n) are obtained as 1.88 which is ˜94% of the theoretical value, i.e., 2, suggesting that the reaction prefers an ideal two-electron pathway (H₂→2H++2e−) for HOR.
(iv) The theoretical first principles studies of hydrogen adsorption free energies (ΔGH*), as well as cohesive energy calculations, strongly substantiate the experimental results (shown in detail in the EXAMPLES) of HOR characterizations.
(v) Theoretical studies elucidate that Pt-doped Ti₅Si₃ demonstrates a reaction barrier with a ΔGH* of ˜0.18 eV which is significantly lower than pure Ti₅Si₃ (0.26 eV).
(vi) Introduction or alloying of Pt into the Ti₅Si₃ lattice marginally increases the cohesive energy and thus, adds to the overall stability of Pt-containing Ti₅Si₃ which is an improvement as compared to pure non-Pt-containing Ti₅Si₃ that is ascribed, e.g., to the presence of stronger Pt—Si bonds in comparison to Ti—Si bonds (calculated E_{coh} for pure Ti₅Si₃ is −47.38 eV/formula unit vs. −47.41 eV/formula unit for Ti_{4.5}Pt_{0.5}Si₃).

The excellent electrocatalytic activity displayed by the novel electrocatalysts in half-cells and single cell PEMFC tests, and superior long-term stability exhibited by the novel solid solution electrocatalyst compositions make these inventive electrocatalyst alloy compositions suitable for use in PEMFC and metal-air batteries, in order to replace or minimize the need for using benchmark and highly expensive Pt, IrO₂, and RuO₂ electrocatalysts.

### EXAMPLES

Pt-doped or alloyed titanium silicide [(Ti₍₁₋ₓ₎Ptₓ)₅Si₃] (0<x<1)-based solid solution electrocatalysts are identified and engineered for hydrogen oxidation reaction (HOR) followed by the density functional theory (DFT) calculations, supporting the experimental findings of high electrocatalytic activity as well as electrochemical and structural stability of (Ti₍₁₋ₓ₎Ptₓ)₅Si₃ electrocatalysts, synthesized via simple, scalable, and economical high energy mechanical milling process. The experimental results herein revealed the lower HOR electrocatalytic activity of pure non-Pt-containing Ti₅Si₃, whereas Pt-alloyed or doped samples demonstrated significant improvement in the HOR electrocatalytic activity and reaction kinetics. The pure non-Pt alloyed Ti₅Si₃ exhibited the charge transfer resistance (R_{ct}) of ˜43 Ω cm² whereas ˜3.75 at. % Pt doped silicide (Ti_{0.94}Pt_{0.06})₅Si₃ revealed R_{ct} of ˜16 Ω cm², substantially lower than pure non-Pt alloyed Ti₅Si₃ and comparable to that of commercial Pt/C (˜14 Ω cm²), suggesting the beneficial improvement in the overall charge transfer and reaction kinetics of Pt-doped or alloyed Ti₅Si₃. In addition, the HOR peak current density (at ˜0.05 V vs. RHE) for Pt/C, 2.5 and 3.75% Pt-doped Ti₅Si₃ is obtained as ˜0.9, 0.54 and 0.75 mA cm⁻², respectively, significantly higher than that of pure non-Pt alloyed Ti₅Si₃ (˜0.22 mAcm⁻²). Such improvements in the charge transfer kinetics and HOR performance were successfully validated by the DFT calculations, revealing the optimal hydrogen adsorption free energies (ΔGH*) and cohesive energy (−E_{coh}) for the Pt-incorporated Ti₅Si₃. The electrochemical chronoamperometry-based durability test conducted for (Ti_{0.94}Pt_{0.06})₅Si₃ in the H₂ saturated 1N H₂SO₄ displayed minimal current density loss, indicating good electrochemical stability towards HOR. The electrochemical results were competently validated by the theoretical first principles studies demonstrating the promise of ultra-low PGM-containing (Ti_{0.94}Pt_{0.06})₅Si₃ electrocatalyst for HOR, which is imperative for the development of earth abundant and reduced PGM-based electrocatalysts for PEMFCs.

### 1. Experimental Methodology

### 1.1 Synthesis of Ti₅Si₃ and (Ti₍₁₋ₓ₎Ptₓ)₅Si₃; 0<x<1

Elemental titanium (99.9%, −325 mesh), silicon (99.9%, −325 mesh), and 40% Pt/C (Alfa Aesar) were used as precursors for the synthesis of electrocatalysts. The illustration of this synthesis process is depicted in FIG. 1. For synthesis of Ti₅Si₃ and (Ti₍₁₋ₓ₎Ptₓ)₅Si₃, 0<x<1 (x=0.04 and 0.06), elemental powder mixtures were prepared according to the elemental stoichiometry. The blended powder mixtures were then loaded into stainless steel (SS) vials containing SS balls with a diameter of 2 mm as the milling media. The ball to powder weight ratio (BPR) was utilized as 5:1. The mixtures were then subjected to dry milling in a high energy Shaker Mill (8000, Spex Industries, Edison, NJ) for 195 minutes to generate the Ti₅Si₃ phase.

### 1.2 Structural Characterization

X-ray diffraction (XRD) was used for conducting the qualitative phase analysis using Philips XPERT PRO system employing CuKα radiation source (λ=0.15406 nm) at an operating current and voltage of 40 mA and 45 kV, respectively. Scanning electron microscopy (SEM) was used to investigate the microstructure of the synthesized materials and energy dispersive x-ray spectroscopy (EDX) was employed for obtaining the elemental analysis and distribution of elements. To investigate the oxidation states of elements in the as-synthesized electrocatalysts, X-ray photoelectron spectroscopy (XPS, ESCALAB 250 Xi) was performed relative to the oxidation states of the elements in the as-synthesized electrocatalysts.

### 1.3 Electrochemical Characterization

The electrochemical characterizations of the electrocatalysts were conducted using a H₂ saturated 1N sulfuric acid (H₂SO₄) solution at 40° C. (using a Fisher Scientific 910 Isotemp refrigerator circulator), and utilizing an electrochemical workstation (VersaSTAT 3, Princeton Applied Research). A three-electrode configuration was used for the test cell setup. The working electrodes were prepared using the electrocatalyst ink consisting of 85 wt. % catalyst and 15 wt. % Nafion 117 (5 wt. % solution in lower aliphatic alcohols, Aldrich) that was spread on the teflonized carbon paper (total catalyst loading of ˜0.4 mg cm⁻²). A Pt wire and mercury/mercurous sulfate (Hg/Hg₂SO₄) electrode (XR-200, Hach) (+0.65V vs RHE) were used as the counter electrode and reference electrode, respectively. The electrochemical performance for HOR of the non-Pt-containing unalloyed Ti₅Si₃ and Pt-doped or alloyed Ti₅Si₃ was compared with the state-of-the-art Pt/C electrocatalyst. The electrochemical characterizations of commercial 40% Pt/C electrocatalyst (Alfa Aesar, 0.4 mg of Pt loading on 1 cm⁻² area) were also conducted under the same operating conditions.

Electrochemical impedance spectroscopy (EIS) was used to investigate the ohmic resistance (R_{Ω}) (which includes resistance of components including electrolyte and electrode) and the charge transfer resistance (R_{ct}) of the synthesized electro-catalyst materials. The frequency range of 100 mHz-100 kHz at ˜0.05 V and 10 mV amplitude were used for EIS characterization. The ZView software from Scribner Associates with circuit models, R_{Ω}(R_{ct}Q₁Wₒ), where Q₁ is constant phase element, representing capacitance behavior of the catalyst surface and Wₒ is open circuit terminus Warburg element, was used for comparing and correlating the experimentally obtained EIS data. The resistance value of R_{Ω} was used for calculating ohmic loss correction (iR_{Ω}) in the LSV curves of the electrocatalyst materials and the charge transfer resistance (R_{ct}) used to study the HOR kinetics.

The cyclic voltammetry (CV) curves were obtained by scanning the potential between −0.1 V (vs RHE) and 1 V (vs RHE) at scan rate of 10 mV s⁻¹. The linear sweep voltammetry (LSV) was carried out by scanning the potential between 0 V (vs RHE) to 0.35 V (vs RHE) at 10 mV s⁻¹. LSV of the electrocatalyst materials were iR_{Ω} corrected, where R_{Ω} is the ohmic resistance determined from electrochemical impedance spectroscopy (EIS) analysis.

A rotating disk electrode (RDE) was employed to study the HOR kinetics. The catalyst ink (85 wt. % catalyst and 15 wt. % Nafion 117) was sonicated and coated to a glassy carbon (GC) disk (geometric area=0.19 cm²) followed by drying in air at room temperature. A thin layer of the synthesized electrocatalyst (1.15 mg cm⁻²) applied on the surface of the disk was used as the working electrode. The Pt wire and Hg/Hg₂SO₄ were used as counter electrode reference electrode, respectively. The polarization studies were carried out in 1N H₂SO₄ at 40° C. in a H₂ stream with a rotation speed of 100, 400, 900, and 1600, respectively. The Koutechy-Levich equation was employed to evaluate the number of electrons involved in the reaction (n):

$${i}^{- 1} = {i}_{k}^{- 1} + {i}_{L}^{- 1}$$

$${i}_{L} = 0.62 n F {A}_{e} {D}_{0}^{2 / 3} {ω}^{1 / 2} {v}^{- 1 / 6} {Co}^{*}$$

wherein, i_{L} is the limiting current (A), iₖ is the kinetic current (A) observed in the absence of mass transfer limitations, F is Faraday constant (96485 C mol⁻¹), Aₑ is the geometric area of the electrode (0.19 cm²), D₀ is diffusivity of H₂ in the electrolyte solution (5×10⁻⁵ cm² s⁻¹), ω is rotation speed (rad s⁻¹), ν is the kinematic viscosity of the electrolyte (0.01 cm² s⁻¹), Co* is the bulk concentration of H₂ in 1N H₂SO₄ (7.8×10⁻⁷ mol cm⁻³).

The electrochemical stability of the electrocatalysts was studied by conducting chronoamperometry (CA) (current density vs time) for 24 h using H₂ saturated 1N H₂SO₄ as the electrolyte at 40° C. at a constant voltage of ˜0.05V vs RHE, the typical potential used for assessing HOR. An inductively coupled plasma optical emission spectroscopy (ICP-OES, iCAP 6500 duo Thermo Fisher) was used to investigate the dissolution of electrocatalyst materials after the stability tests. Three independently prepared electrocatalyst samples were subjected to CA testing and the electrolyte solution collected was then subjected to ICP analysis following the stability tests.

Membrane electrode assemblies (MEAs) were prepared for the single cell studies. The electrocatalyst ink was generated by mixing 85 wt. % electrocatalyst powder and 15 wt. % Nafion 117 solution (5 wt. % solution in lower aliphatic alcohols, Sigma-Aldrich) for the anodes (working electrode) utilizing a total mass loading of ˜0.2 mg cm⁻². For comparison, commercially obtained 40% Pt/C (Alfa Aesar) was also studied as the anode electrocatalyst in single cell tests using an identical loading of 0.2 mg cm⁻². Correspondingly, for the cathode, the electrocatalyst ink was prepared using 40% Pt/C electro-catalyst (Alfa Aesar) as the active electrocatalyst utilizing the same amount as mentioned above, i.e., 85 wt. % catalyst and 15 wt. % Nafion 117 solution (5 wt. % solution in lower aliphatic alcohols, Sigma-Aldrich). Amass loading of 0.3 mg of Pt cm⁻² was used for the cathode. Thus, an electrocatalyst loading of ˜0.2 mg of cm⁻² was used for the Pt/C and Ti_{4.7}Pt_{0.3}Si₃ anode electrocatalysts while Pt/C as the cathode electrocatalyst was loaded at an electrocatalyst loading of 0.3 mg cm⁻² under H₂/O₂ flow conditions given below.

The electrodes were prepared by spreading the electrocatalyst ink on teflonized carbon paper. The MEA was fabricated by using a Nafion 115 membrane which was sandwiched between the anode and cathode. Prior to the MEA, the Nafion 115 membrane was pretreated first with a 3 wt. % hydrogen peroxide solution to its boiling point to oxidize any organic impurities. It was then boiled in D.I. water followed by boiling 1N sulfuric acid solution to eliminate any impurities. Finally, it was treated several times in D.I. water to remove any traces of residual acid. This membrane was then stored in D.I. water to avoid dehydration. The Nafion 115 membrane was sandwiched between the anode and cathode by hot-pressing using a 25T hydraulic lamination hot press with dual temperature controller (MTI Corporation). The hot press was operated at a temperature of 125° C. and pressure of 40 atmospheres applied for 30 see to ensure good contact between the electrodes and the membrane. This MEA prepared in the above manner was then used for conducting the single cell PEMFC test analysis. The fuel cell tests were carried out using the fuel cell test set up obtained from Electrochem Incorporation at 80° C. and 0.1 MPa using ultra-high purity (UHP)-H₂ (200 ml/min) and UHP-O₂ (300 ml/min) as the reactant gases and 1N sulfuric acid electrolyte solution.

### 2. Computational Methodology

Traditionally the electrocatalytic activity of an HER/HOR electrocatalyst can be described by a single parameter ΔG_{H*} which is the free energy of adsorbed hydrogen atom on the electro-catalytic surface and the overall catalytic reaction obtains the optimum rate when ΔG_{H*} becomes close to 0 eV. The closer the value of ΔG_{H*} to zero indicates the attainment of more optimal adsorption and desorption conditions for hydrogen atoms at the electro-catalyst surface and thus, a higher overall electro-catalytic activity of the material will be observed. In general, ΔG_{H*} is represented by the following relation:

$$Δ {G}_{{H}^{*}} = Δ {E}_{{H}^{*}} + Δ ZPE - T Δ S \qquad Equation 1$$

wherein, the reaction energy ΔG_{H*} is calculated using the density functional theory methodology (DFT) as follows:

$$Δ {E}_{{H}^{*}} = E ( slab + nH ) - E ( slab + ( n - 1 ) H ) - 1 / 2 E ( {H}_{2} ) \qquad Equation 2$$

wherein, E(slab+nH) is the total energy of a catalyst surface slab with “n” hydrogen atoms adsorbed on the surface, E(slab+(n−1)H) is the total energy of the corresponding electrocatalyst surface slab with (n−1) hydrogen atoms (after removal of one hydrogen atom from the given site) and E(H₂) is the total energy of the hydrogen molecule in the gas phase. Also, the zero point energy correction ΔZPE minus the entropy term TAS has been taken equal to 0.24 eV.

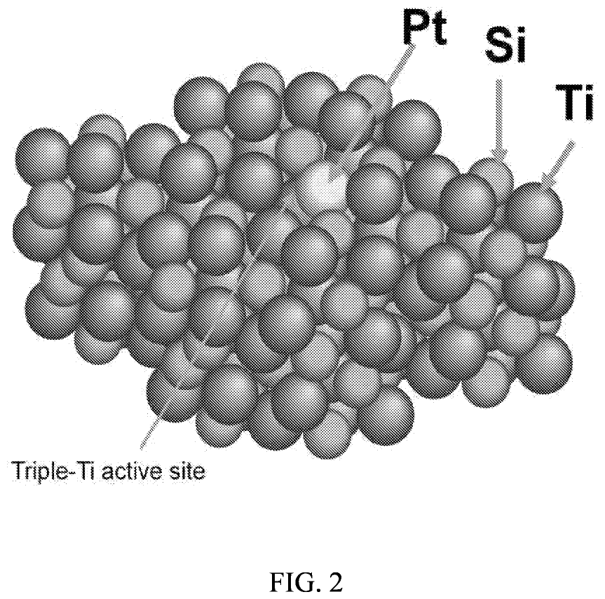

For calculations of the bulk and surface properties of pure and Pt-doped or alloyed Ti₅Si₃, a hexagonal crystal structure P6₃/mcm (space group #193) with two formula units in the unit cell and the lattice parameters a=b=7.465 Å and c=5.163 Å was considered as shown in FIG. 2. The presence of Pt atom is also shown in FIG. 2. In all the calculations, one monolayer of H-coverage of the (0001) surface was used. For the present computational study of hydrogen binding energies ΔG_{H*} as qualitative descriptors of the HOR catalytic activity, the crystallographic plane (0001) with triple-Ti sites denoted by the arrow on FIG. 2 were considered to be electrocatalytically active.

The common surface slab used in the DFT study consisted of five atomic layers (three pure Ti layers and two Ti—Si mixed once) corresponding to one lattice parameter in c direction which was perpendicular to (0001) crystallographic plane and separated by vacuum layer of ˜20 Å to prevent any interaction between the slab and its images. The first two layers were fixed with bulk structural parameters, while the remaining three top layers were allowed to relax together with all the adsorbed hydrogen atoms on the surface. Since, the purpose of the present theoretical study was to elucidate an effect of Pt introduction on the overall electrocatalytic activity of Ti₅Si₃, only one minimal amount of Pt was chosen for the calculation of ΔG_{H*} and other bulk and surface properties of the corresponding alloys. Thus, the bulk properties, such as the electronic structure and the cohesive energy were calculated for Ti₅Si₃ and Ti_{4.5}Pt_{0.5}Si₃ (with one Pt atom placed on the Ti-site within the 16 atom unit cell), while the free energies of hydrogen adsorption on the pure and Pt-containing (0001) Ti₅Si₃ surfaces were calculated at the triple-Ti active site for pure Ti₅Si₃ surface and at the corresponding active site comprised of two Ti and one Pt site for the Pt-doped or alloyed compound shown in FIG. 2. Note, Ti_{4.5}Pt_{0.5}Si₃ corresponds to 24.5 wt. % or 6.26 at. % of Pt.

In the present study for all the DFT calculations, the Vienna Ab-initio Simulation Package (VASP) was used within the projector-augmented wave method and the generalized gradient approximation for the exchange-correlation energy. The standard projector augmented-wave (PAW) potentials were employed for the Ti, Si and Pt potentials containing four, four, and ten valence electrons, respectively. For all the materials considered in this study, the plane wave cutoff energy of 520 eV was chosen to maintain a high accuracy of the total energy calculations. The lattice parameters and internal positions of atoms were fully optimized employing the double relaxation procedure. The total electronic energies were converged to within 10⁻⁵ eV/un.cell resulting in the residual force components on each atom to be lower than 0.01 eV/Å/atom. The Monkhorst-Pack scheme was used to sample the Brillouin Zone and generate the k-point grid for all materials considered in the study.

### 3. Experimental Results and Discussion

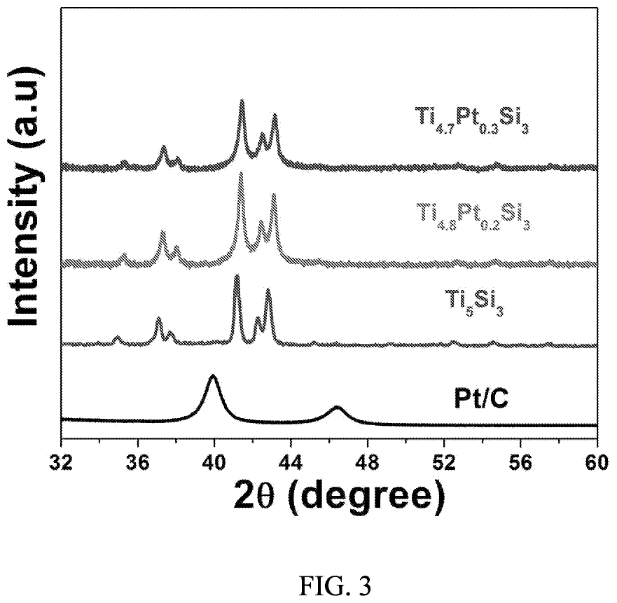

FIG. 3 illustrates the XRD spectrum of commercial Pt/C with observable peaks. The XRD patterns of as-synthesized Ti₅Si₃ reveals the hexagonal structure (P6₃/mcm) without the presence of any secondary phases of Ti and Si containing compounds as well as any impurities arising from the high-energy ball milling process. The as-synthesized Ti₅Si₃ reveals lattice parameters of a=7.45 Å and c=5.14 Å and unit cell volume (V) of ˜285.28 Å³ which are almost identical to the values of the lattice parameters of pure and bulk Ti₅Si₃. This result indicates the formation of pure and crystalline Ti₅Si₃ powder, devoid of any undesired impurities.

Also, as can be seen from FIG. 3, the Pt-doped or alloyed samples, (Ti₍₁₋ₓ₎Ptₓ)₅Si₃ (x=0.04 and 0.06), also denoted as Ti_{4.8}Pt_{0.2}Si₃ and Ti_{4.7}Pt_{0.3}Si₃ exhibit the XRD patterns similar to the hexagonal structured pristine non-Pt alloyed Ti₅Si₃. This indicates that there was successful incorporation of Pt as a solute into the Ti₅Si₃ lattice, without creating any secondary phases of Ti/Si or Pt containing alloys or compounds, suggesting the formation of single-phase solid solution electrocatalysts. Also, all the peaks in the XRD patterns (Ti₍₁₋ₓ₎Ptₓ)₅Si₃ (x=0.04 and 0.06) in FIG. 3 exhibit a slight positive shift (towards a higher angle) in the peak positions, indicting a slight lattice contraction as indicated by the unit cell volume in Table 1.

TABLE 1
Results of physical and electrochemical characterizations of HOR electrocatalysts.

| | | | | Current | |
|---|---|---|---|---|---|
| | | | | density at | |
| | Lattice | Unit cell | | 0.05 V | Tafel |
| | parameters | volume | R_{ct} | vs. RHE | slope |
| Electrocatalyst | (Å) | (Å³) | (Ω cm²) | (mA cm⁻²) | (mVdec⁻¹) |
| Ti₅Si₃ | a = 7.4520, | 285.28 | 43 | 0.22 | 175.6 |
| | c = 5.1452 | | | | |
| Ti_{4.8}Pt_{0.2}Si₃ | a = 7.4436, | 283.41 | 22 | 0.54 | 146.9 |
| | c = 5.1275 | | | | |
| Ti_{4.7}Pt_{0.3}Si₃ | a = 7.4315, | 282.09 | 16 | 0.75 | 136.2 |
| | c = 5.1160 | | | | |
| Pt/C | a = b = | 63.56 | 14 | 0.9 | 112.1 |
| | c− = 3.9110 | | | | |

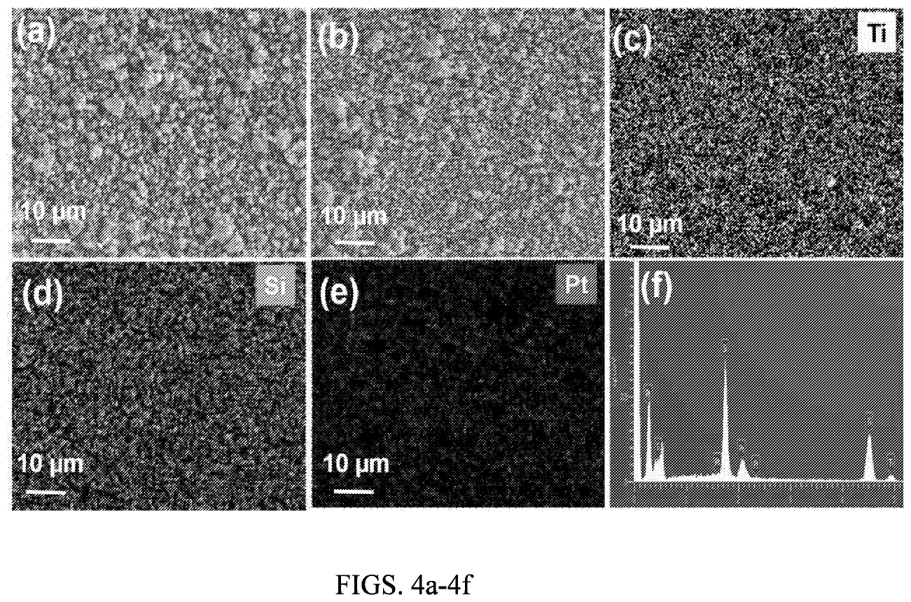

Scanning electron microscopy (SEM) micrographs of the as-synthesized Ti₅Si₃ and Ti_{4.7}Pt_{0.3}Si₃ are shown in FIGS. 4a and 4b, respectively. These SEM images (FIGS. 4a and 4b) reveal the fragmented powder particles in the range of 1-10 μm. The energy dispersive X-ray (EDX) spectroscopy based elemental mapping images of Ti_{4.7}Pt_{0.3}Si₃ (FIGS. 4c, 4d, and 4e) demonstrate the uniform and homogeneous distribution of the Ti, Si, and Pt within the as-synthesized electrocatalyst powder devoid of the presence of any undesired secondary impurity elements. In addition, based on the quantitative elemental analysis (EDX, FIG. 4f), the percentage atomic content of Ti, Si and, Pt is obtained as ˜59.80, 36.58, and 3.62, in good agreement with the selected nominal as well as XPS composition (˜59.43:37.24:3.33).

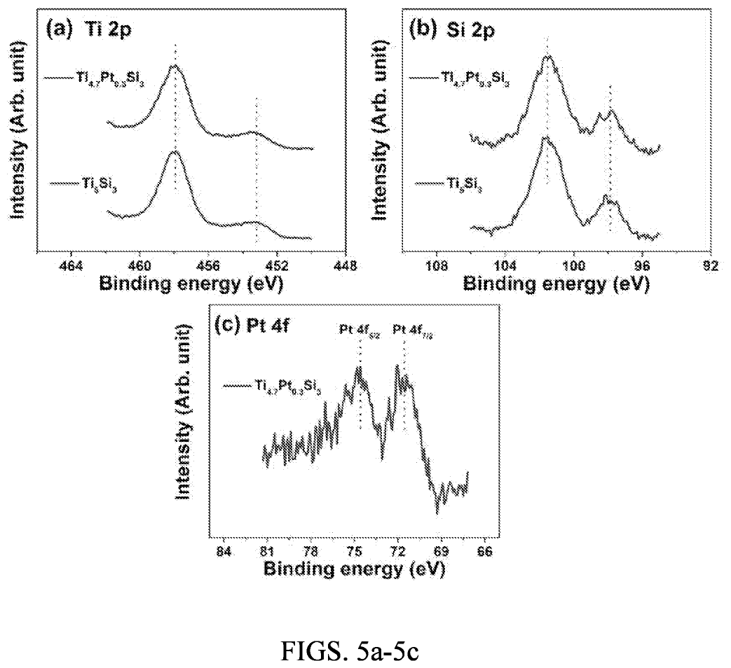

The surface chemical states of the as-synthesized electrocatalysts were investigated from the XPS analysis. As depicted in FIG. 5a, the XPS peaks at binding energy of ˜453.2 eV and ˜458 eV correspond to the titanium in silicide, Ti₅Si₃ and surface oxidized titanium (TiOₓ) implying that the surface of the silicide electrocatalyst is primarily composed of titanium oxide layer. The as-synthesized Ti₅Si₃ and Ti_{4.7}Pt_{0.3}Si₃ also exhibit similar XPS binding energies suggesting that there is no change in the chemical states of undoped or pure and Pt-doped or alloyed Ti₅Si₃ samples. In other words, the alloying of Pt into the Ti₅Si₃ silicide does not change the chemical state of Ti in the alloyed silicide. Similarly, as can be seen from FIG. 5b, the Si 2p peaks at ˜98 eV and ˜101.9 eV can be ascribed to the binding energy of silicon in the silicide, Ti₅Si₃ and surface oxidized silicon (SiOₓ) suggesting that the surface of the silicide consists of silicon oxides. Furthermore, as depicted in FIG. 5c, the peak binding energies at ˜71.3 eV and ˜74.4 eV are ascribed to the Pt4f_{7/2} and Pt4f_{5/2}, respectively, corresponding to the elemental state of platinum, Pt(0).

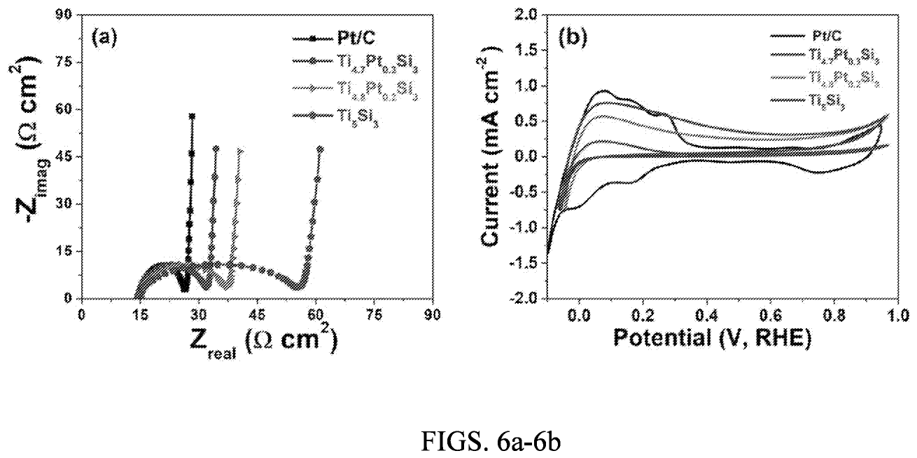

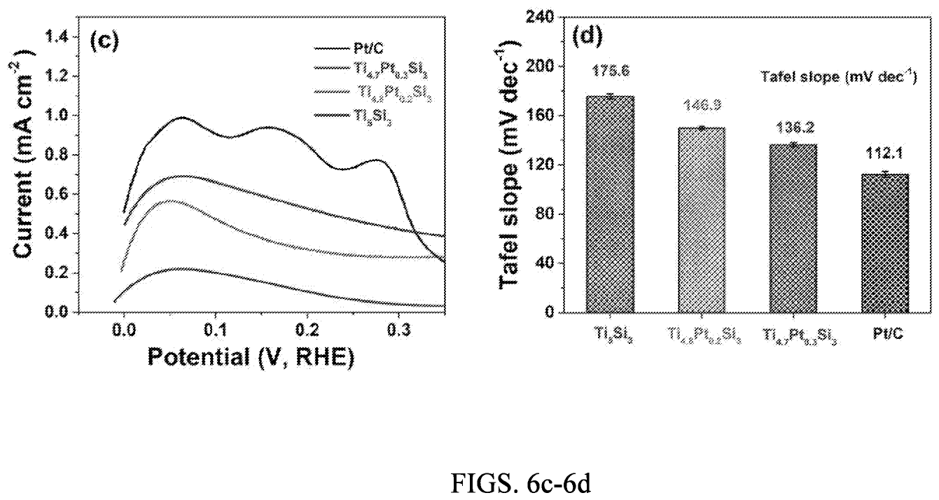

Electrochemical characterization was conducted to ascertain the electrochemical response for HOR for the novel Pt alloyed electrocatalyst. In order to study the hydrogen oxidation reaction kinetics of the as-synthesized electrocatalysts, the electrochemical impedance spectroscopy (EIS) was performed at a potential of 0.05 V (vs. RHE), the typical potential considered for HOR, in the frequency range of 100 mHz to 100 kHz at an amplitude of 10 mV. As shown in FIG. 6a and Table 1, the as-synthesized pure and non-Pt alloyed Ti₅Si₃ exhibits a charge transfer resistance (R_{ct}) of ˜43 Ω cm² which is significantly higher than the benchmark Pt/C (14 Ω cm²). Furthermore, as shown in FIG. 6a, the Ret of Ti₅Si₃ decreases following the incorporation of Pt. For example, (Ti₍₁₋ₓ₎Ptₓ)₅Si₃, x=0.04 and 0.06) i.e. Ti_{4.8}Pt_{0.2}Si₃ and Ti_{4.7}Pt_{0.3}Si₃ revealed R_{ct} of ˜22 Ω cm² and 16 Ω cm², respectively. This substantial reduction in the R_{ct} measurably observed clearly suggests an improvement in the electronic conductivity as well as favoring the HOR kinetics of Pt alloyed silicide electrocatalysts.

Additionally, FIG. 6b shows the cyclic voltammetry (CV) curves for the as-synthesized electrocatalysts along with that obtained for commercial Pt/C, conducted in the H₂-saturated 1N H₂SO₄ electrolyte solution at 40° C. The hydrogen oxidation peak at ˜0.05 V (vs. RHE) for Pt/C and for the silicide electrocatalysts suggest their electrochemical activity towards HOR. As seen in FIG. 6b, pure Ti₅Si₃ exhibits minimal current density indicating its poor electrochemical activity for HOR whereas a small amount of Pt incorporation in the Ti₅Si₃, i.e., Ti_{4.8}Pt_{0.2}Si₃ and Ti_{4.7}Pt_{0.3}Si₃ revealed improved HOR activity in comparison to the pristine non-Pt alloyed Ti₅Si₃. This result suggests the modification of the electronic structure with the alloying of Pt and a consequence of the reduced charge transfer resistance of Pt containing silicide electrocatalysts measured as indicated above, supported by the DFT (discussed later herein) and EIS results discussed above.

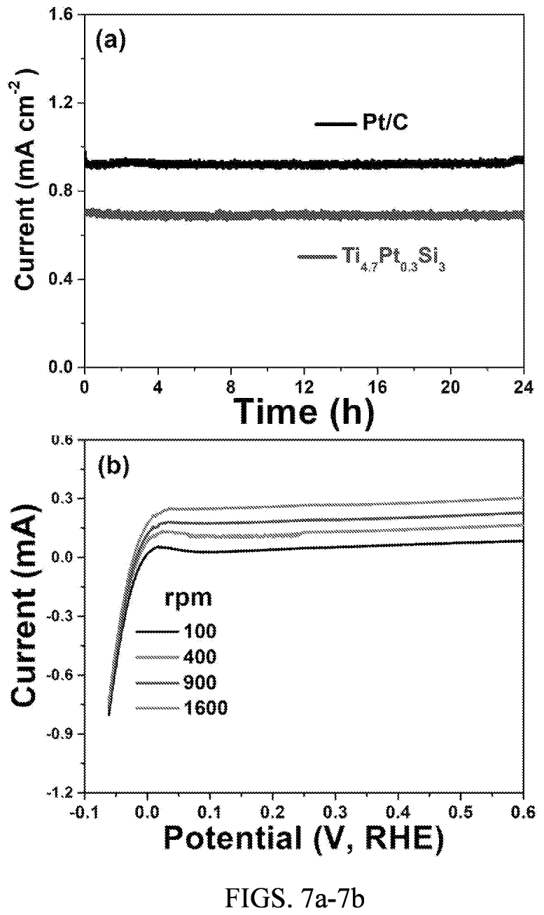

Furthermore, as can be seen from the HOR polarization curves (FIG. 6c), the HOR peak current density (at ˜0.05 V vs. RHE) for Ti₅Si₃ was obtained as ˜0.22 mAcm⁻². Upon Pt incorporation of 2.5 at. %, i.e., for Ti_{4.8}Pt_{0.2}Si₃ a sharp increase in the current density to a value of ˜0.54 mAcm⁻² was obtained. In the case of Ti_{4.7}Pt_{0.3}Si₃ corresponding to only 3.75 at. %, incorporation of Pt, there was further increase in current density to a measured value of ˜0.75 mA cm⁻², almost 3.4× improvement in the current density observed, rendering the system closer to the value measured for Pt/C, (0.9 mA cm⁻²). This improvement in current density measured was again attributed to the optimal hydrogen adsorption free energies (ΔG_{H*}) discussed later herein, and the reduction in charge transfer resistance for the Pt alloyed silicide electrocatalysts. In addition, as can be seen from Tafel slope values (FIG. 6d), there was a steady decrease in the Tafel slopes measured for the Pt alloyed silicide electrocatalysts from the measured value for the as-synthesized non-Pt alloyed Ti₃Si₃. Correspondingly, pure Ti₅Si₃ exhibited a Tafel slope of ˜175.6 mV dec⁻¹ while the Pt alloyed Ti₅Si₃ displayed reduced Tafel slope values of ˜146.9 mV dec⁻¹ for Ti_{4.8}Pt_{0.2}Si₃ and ˜136.2 mV dec⁻¹) for Ti_{4.7}Pt_{0.3}Si₃. These Tafel slope values (an average value calculated from three independently synthesized electrocatalysts) are clearly a reflection of the enhanced electrocatalytic activity for Pt alloyed silicides compared to the non-Pt alloyed silicide electrocatalysts. Following the above measurements, the electrocatalytic stability of the synthesized Pt alloyed silicide, Ti_{4.7}Pt_{0.3}Si₃ showing the best electrochemical performance was determined and compared with the state of the art Pt/C electrocatalyst. Hence, both Pt/C and the synthesized Pt alloyed silicide, Ti_{4.7}Pt_{0.3}Si₃ were subjected to chronoamperometry analysis for 24 h at a constant potential of 0.05 V (vs. RHE), which is closer to 0 V (standard redox potential of HOR). As shown in FIG. 7a, the as-synthesized Ti_{4.7}Pt_{0.3}Si₃ displaying the best electrochemical performance exhibited excellent electrochemical stability, with a minimum dissolution of the elements (Ti, Si, and Pt dissolution ˜1.73±0.02, ˜0.81±0.03, and ˜0.05±0.01 ppm, respectively) and current density decay retaining ˜98-99% of the initial current density, comparable to that of Pt/C. Elemental chemical analyses were obtained from three independently synthesized electrocatalysts using ICP.

Subsequent to the electrochemical characterizations discussed above, in order to gain more insights in the electrochemical kinetics, rotating disk electrode (RDE) analysis was performed and the results are shown in FIG. 7b. This figure shows the polarization curves for the RDE tests carried out in 1N H₂SO₄ solution at 40° C. in H₂ stream with the rotation speeds of 100, 400, 900, and 1600 rpm. Using the Koutechy-Levich equation with a F˜96485 C mol⁻¹, Aₑ˜0.19 cm², D₀˜5×10⁻⁵ cm² s⁻¹, ν˜0.01 cm² s⁻¹, and Cₒ*˜7.8×10⁻⁷ mol cm⁻³, the number of electrons produced in the reaction (n) are obtained as 1.88 which is ˜94% of the theoretical value, i.e. 2, suggesting that the reaction preferred a two-electron pathway (H₂→2H++2e−) for HOR.

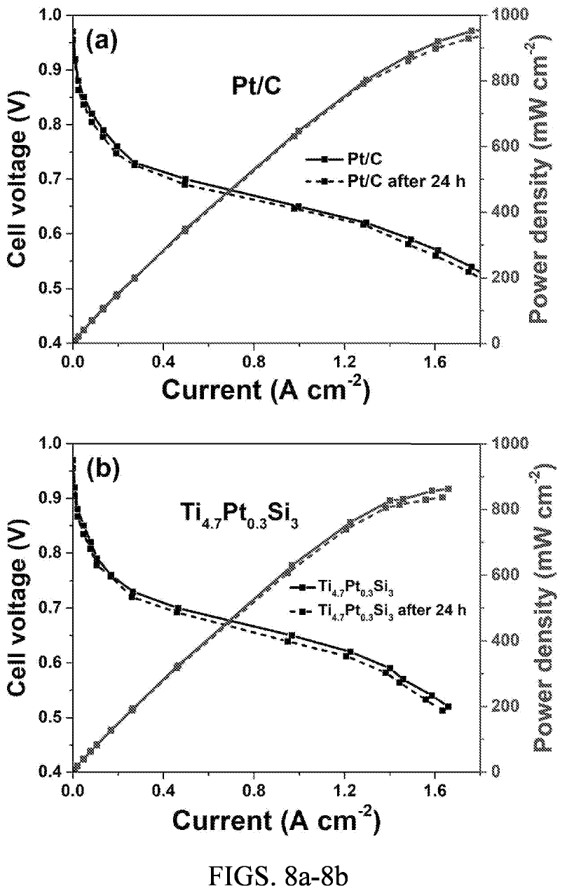

The performance of the optimal electrocatalyst, Ti_{4.7}Pt_{0.3}Si₃ was further evaluated in a single fuel cell to ascertain the true electrochemical response of the synthesized electrocatalyst. FIGS. 8a and 8b show the current-voltage and power density curves obtained for a single PEMFC using state of the art Pt/C electrocatalysts serving as the anode and cathode as well as for synthesized Ti_{4.7}Pt_{0.3}Si₃ serving as the anode and Pt/C as the cathode electrocatalyst. An electrocatalyst loading of ˜0.2 mg of cm⁻² was used for the Pt/C and Ti_{4.7}Si_{0.3}Si₃ anode electrocatalysts while Pt/C as the cathode electrocatalyst was loaded at an electrocatalyst loading of 0.3 mg cm⁻² under H₂/O₂ flow conditions as described above. As shown in FIGS. 8a and 8b, the open circuit potential for the Pt/C, PEMFC was obtained as ˜0.97 which is comparable to the as-synthesized Ti_{4.7}Pt_{0.3}Si₃. In addition, the maximum power density obtained using the single PEMFC with Pt/C (FIG. 8a) as anode electrocatalyst is ˜960 mW cm⁻². As depicted in FIG. 8b, the as-synthesized Ti_{4.7}Pt_{0.3}Si₃ exhibited the maximum power density of ˜855 mW cm⁻², suggesting good electrocatalytic performance towards HOR. In addition, the current-voltage and power density curves plotted after 24 h HOR operation exhibit negligible change in power density values, indicating the excellent electrocatalytic activity of the synthesized Pt alloyed Ti_{4.7}Pt_{0.3}Si₃ containing only 3.75 at. % Pt for acid mediated PEM based HOR.

### 4. Computational Results and Discussion

As mentioned earlier, the main purpose of the computational study presented herein is to elucidate the effect of Pt doping or alloying and solid solution formation on the electrocatalytic activity of parent unalloyed Ti₅Si₃ during HOR. In order to shed light on this reaction, the electronic structure, hydrogen adsorption free energies ΔG_{H*} as well as the cohesive energies of the materials have been calculated for the pure and Pt-alloyed Ti₅Si₃, serving as a qualitative measure of the structural and chemical stability. Additionally, as discussed above, for a good HOR electrocatalyst, it is vital that the free energy of adsorbed H (ΔG_{H*}) be close to zero such that the hydrogen atoms would be able to easily adsorb and desorb from the surface during the HOR process. Thus, the strategy involving modifying the electrocatalytic surface electronic structure juxtaposed with changing the chemical composition together, in such a way that the resulting ΔG_{H*} becomes close to zero, may also substantially improve the electro-catalytic activity of the material. To achieve this and ascertain the nature of the alloyed electrocatalyst, DFT calculated ΔG_{H*} has been determined from Equations 1 and 2.

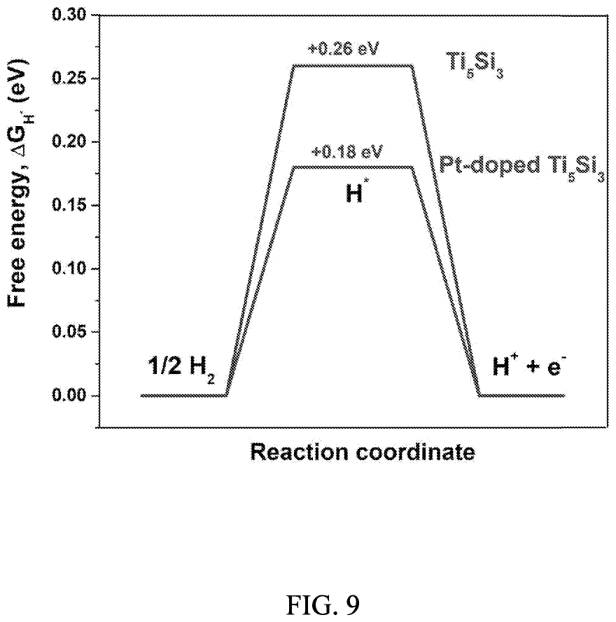

Accordingly, FIG. 9 shows the calculated hydrogen adsorption free energies ΔG_{H*} determined for pure and Pt-alloyed Ti₅Si₃ at (0001) crystallographic plane, which are also tabulated in Table 2. It can be seen that the value of ΔG_{H*} for the pure non-Pt alloyed Ti₅Si₃ is relatively large (+0.26 eV) and appears quite far from the optimal (zero) value resulting in too weak interaction between the hydrogen atoms and the electrocatalyst surface, implying that the adsorption of the hydrogen atoms on the electrocatalyst surface is practically impossible, thus providing suboptimal electrocatalytic activity, as also witnessed experimentally in the present study. However, upon introduction of Pt into the Ti₅Si₃ lattice substituting for Ti decreases ΔG_{H*} noticeably, bringing the value towards the more optimal energy value (+0.18 eV). This indicates an increase in the strength of the hydrogen-surface interaction due to the significantly stronger Pt5d-H1s bonds compared to the Ti3d-H1s bonds (bond dissociation energies for diatomic Pt—H and Ti—H molecules are 330 kJ mol⁻¹ vs. 204.6 kJ mol⁻¹, respectively). This effect of Pt introduction is expected to noticeably improve the electrocatalytic activity of Pt-alloyed Ti₅Si₃ in comparison to the pristine Ti₅Si₃, which is competently supported by the experimental results discussed herein. Another aspect to be highlighted in the present theoretical study of the invention is the structural and electrochemical stability of the system for which the cohesive energy E_{coh} can be considered as the qualitative indicator. A higher E_{coh} (the more negative value) value would imply a more chemically robust and durable electro-catalyst material which can be thus expected to display long term electrochemical stability and durability when considered over the entire duration of the long term HOR electro-catalytic process. The calculated E_{coh} value for all the synthesized electrocatalyst silicide materials are also tabulated in Table 2. As shown in Table 2, an introduction of Pt into the Ti₅Si₃ lattice slightly increases the cohesive energy and thus, makes the overall chemical and electrochemical stability of Ti_{4.5}Pt_{0.5}Si₃ even better than that of pure Ti₅Si₃ which can be ascribed to the presence of stronger Pt—Si bonds in comparison to Ti—Si bonds (calculated E_{coh} for pure Ti₅Si₃ is −47.38 eV/formula unit vs. −47.41 eV/formula unit for Ti_{4.5}Pt_{0.5}Si₃). Thus, Pt introduction does not compromise the structural and electrochemical stability and indeed makes this material capable of withstanding the harsh electrochemical conditions during the acid mediated HOR process.

TABLE 2
Calculated free energy of hydrogen adsorption ΔGH* and cohesive
energy −Ecoh for pure and Pt-doped or alloyed Ti₅Si₃.

| | Delta G_{H}* | −E_{coh} |
|---|---|---|
| Electrocatalyst | (in eV) | (eV/f. un.) |
| Ti₅Si₃ | +0.26 | 47.38 |
| Ti_{4.5}Pt_{0.5}Si₃ | +0.18 | 47.41 |

Thus, based on results of the DFT study, Pt-doped or alloyed Ti₅Si₃ is expected to demonstrate improved electrocatalytic activity due to the more optimal hydrogen adsorption onto the silicide electrocatalyst surface in comparison to that of pure non-Pt alloyed Ti₅Si₃ material combined with marginally improved structural and chemical stability with no adverse influence thus rendering the material a good candidate for HOR electrocatalyst exhibiting promising high performance response as clearly demonstrated by the systematic experimental results discussed herein.

### 5. Conclusions

In summary, the Examples demonstrate an experimental and complementary theoretical investigation of Pt-doped or alloyed solid solution Ti₅Si₃ as potential anode electrocatalysts for acid-mediated PEMFCs. The XRD analyses indicated the formation of a single-phase solid solution for all of the Pt-alloyed Ti₅Si₃ alloys synthesized via a simple and scalable high energy mechanical milling approach. The as-synthesized Ti_{4.7}Pt_{0.3}Si₃ powders demonstrated superior electrochemical activity in comparison to the Ti_{4.8}Pt_{0.2}Si₃ and non-Pt alloyed pure Ti₅Si₃ making it an optimal Pt containing solid solution electrocatalytically active composition. The experimental results demonstrate a significantly lower charge transfer resistance (R_{ct}) for ˜3.75 at. % Pt doped silicide (Ti_{4.7}Pt_{0.3}Si₃˜16 Ω cm²) in comparison to pure Ti₅Si₃ (R_{ct}˜43 Ω cm²), almost matching that of state-of-the-art Pt/C (˜14 Ω cm²), indicating the beneficial improvement in the electronic conductivity and reaction kinetics upon Pt incorporation. In addition, the Ti_{4.7}Pt_{0.3}Si₃ electrocatalyst revealed a higher electrocatalytic activity for HOR, comparable to state-of-the-art Pt/C in comparison to 2.5 at. % Pt containing Ti_{4.8}Pt_{0.2}Si₃ and pure non-Pt containing Ti₅Si₃. Such improved electrocatalytic activity upon Pt incorporation was successfully validated by the DFT calculations which unveiled that the Pt-containing Ti₅Si₃ exhibited optimal hydrogen adsorption free energies (ΔG_{H*}˜0.18 eV), lower than that of pure non-Pt alloyed Ti₅Si₃ (˜0.26 eV), suggesting the reduced reaction barrier and enhanced HOR kinetics. In addition, the optimal composition of Ti_{4.7}Pt_{0.3}Si₃ electrocatalyst containing only 3.75 at. % Pt demonstrated good electrochemical durability under HOR operation conditions in both half-cell as well as single cell PEMFC tests, comparable to Pt/C, devoid of any major structural and activity degradation, which was also evidently supported by the theoretical calculations of cohesive energy (−E_{coh}). Furthermore, the maximum power density of the reduced PGM-containing anode Ti_{4.7}Pt_{0.3}Si₃ was obtained as 855 mW cm⁻², which is as good as that of the conventional Pt/C of 960 mW cm⁻². The results obtained and documented in this invention herein thus strongly indicate that the as-synthesized Pt alloyed Ti_{4.7}Pt_{0.3}Si₃ electrocatalyst containing only 3.75 at. % Pt is effective for HOR in a PEMFC with much lower cost and comparable performance to that of the benchmark Pt/C.

We claim:

1. An anode electrocatalyst composition, comprising:
a metal silicide alloy-based solid solution of a general formula:
(A₍ₙ₋ₓ₎Bₓ)Si_{y}
wherein A is a transition metal element or mixture or alloy thereof, B is a noble metal element or mixture or alloy thereof, and each of n and x is a positive integer or a positive fractional number, and y is a positive integer, and
wherein the anode electrocatalyst is used in an acid mediated proton exchange membrane-based hydrogen oxidation reaction.

2. The composition of claim 1, wherein A is selected from the group consisting of Ti, Ta, Nb, V, W, Sr, Pb, Sb, Cr, Co, Sn, Fe, Mn, Mo, Ni, and mixtures and alloys thereof.

3. The composition of claim 1, wherein B is selected from the group consisting of Pt, Ir, Ru, Rh, Os, Pd, and mixtures and alloys thereof.

4. The composition of claim 1, wherein the metal silicide alloy-based solid solution has the general formula: (Ti₍₅₋ₓ₎Ptₓ)Si₃ and x is from greater than 0 to less than 5.

5. The composition of claim 4, wherein x is a positive number from 0.2 to 0.5.

6. The composition of claim 1, wherein A, B and Si are in a dry form.

7. The composition of claim 6, wherein the dry form is selected from the group consisting of powder, particles, flakes, rods, tubes, granules, films, and mixtures and combinations thereof.

8. The composition of claim 7, wherein the dry form comprises one or more high specific surface area nanostructured forms.

9. The composition of claim 1, wherein the general formula corresponds to the elemental stoichiometry of A, B and Si.

10. A method of preparing an anode electrocatalyst composition, comprising:
preparing a metal silicide alloy-based solid solution of the general formula:
$$( {A}_{( n - x )} {B}_{x} ) {Si}_{y}$$
wherein A is a transition metal element or mixture or alloy thereof, B is a noble metal element or mixture or alloy thereof, each of n and x is a positive integer or a positive fractional number, and y is a positive integer, comprising:
obtaining A, B and Si in dry form;
combining the A, B and Si to form a dry mixture; and
high energy mechanical milling the dry mixture to form an alloy composition.

11. The method of claim 10, wherein the high energy mechanical milling, comprises loading the dry mixture into a vial containing stainless-steel balls.

12. The method of claim 11, wherein the weight ratio of stainless-steel balls to powder is 5:1.

13. The method of claim 10, wherein the dry form comprises one or more high specific surface area nanostructured forms.

14. A proton exchange membrane fuel cell, comprising:
an anode electrocatalyst composition, comprising:
a metal silicide alloy-based solid solution of the general formula:
$$( {A}_{( n - x )} {B}_{x} ) {Si}_{y}$$
wherein A is a transition metal element or mixture or alloy thereof, B is a noble metal element or mixture or alloy thereof, and each of n and x is a positive integer or a positive fractional number, and y is a positive integer.

15. The fuel cell of claim 14, wherein A is selected from the group consisting of Ti, Ta, Nb, V, W, Sr, Pb, Sb, Cr, Co, Sn, Fe, Mn, Mo, Ni, and mixtures and alloys thereof.

16. The fuel cell of claim 14, wherein B is selected from the group consisting of Pt, Ir, Ru, Rh, Os, Pd, and mixtures and alloys thereof.

17. The fuel cell of claim 14, wherein the metal silicide alloy-based solid solution has the general formula: (Ti₍₅₋ₓ₎Ptₓ)Si₃ and x is from greater than 0 to less than 5.

18. The fuel cell of claim 17, wherein x is a positive number from 0.2 to 0.5.

19. The fuel cell of claim 14, wherein A, B and Si are in a dry form.

20. The fuel cell of claim 19, wherein the dry form is selected from the group consisting of powder, particles, flakes, rods, tubes, granules, films, and mixtures and combinations thereof.

21. The fuel cell of claim 14, wherein the dry form comprises one or more high specific surface area nanostructured forms.

22. The fuel cell of claim 14, wherein the general formula corresponds to the elemental stoichiometry of A, B and Si.
